(19) United States
(12) Patent Application Publication
(10) Pub. No.: US 2015/0321844 A1
(43) Pub. Date: Nov. 12, 2015

(54) METHOD AND APPARATUS FOR HANDLING MATERIAL IN A PNEUMATIC MATERIALS HANDLING SYSTEM

(71) Applicant: MARICAP OY, Vantaa (FI)

(72) Inventor: Göran SUNDHOLM, Tuusula (FI)

(73) Assignee: MARICAP OY, Vantaa (FI)

(21) Appl. No.: 14/409,971

(22) PCT Filed: Jun. 28, 2013
(86) PCT No.: PCT/FI2013/050718

§ 371 Date: Dec. 19, 2014

(30) Foreign Application Priority Data
Jul. 2, 2012 (FI) 20125763

(51) Int. Cl. B65F 5/00; B65G 53/40

(52) U.S. Cl. CPC B65F 5/005; B65G 53/40

(57) ABSTRACT

Method for handling material in a pneumatic pipe transport system, in which material, such as waste material, is input from an input aperture of an input point (3), such as from the input aperture of a refuse chute or of some other input point, and is conducted along a feeder channel (2) with a shaper device (1) arranged in connection with the input point or in the proximity of it, in which case the material to be handled is conducted into the shaper device and/or through it by the aid of at least partly gravity and/or the suction and/or a pressure difference of the pneumatic pipe transport system. In the method the material is handled with one handling means (10) in a shaper device (1), which handling means is rotated around an axis of rotation when handling material and which handling means comprises an aperture (20), which is arranged eccentrically with respect to the axis of rotation of the handling means, that the rotatable handling means (10) arranges the material to be infed into the proximity of the output aperture and, if necessary, shapes the material, together with at least an edge (18) of the output aperture of the rotary shaper and/or the wall of the output channel (4), when the handling means (10) is rotated with a drive device (7).

### BACKGROUND OF THE INVENTION

The object of the invention is a method as defined in the preamble of claim 1.

Another object of the invention is an apparatus as defined in the preamble of claim 9.

The invention relates generally to materials handling systems, such as partial-vacuum transporting systems, more particularly to the collection and conveying of wastes, such as to the conveying of household wastes.

Systems wherein wastes are conveyed in piping by means of an air current produced by a pressure difference or suction are known in the art. In these, wastes are conveyed long distances in the piping. It is typical to these systems that a partial-vacuum apparatus is used to achieve a pressure difference, in which apparatus a partial vacuum is achieved in the conveying pipe with partial-vacuum generators, such as with vacuum pumps or with an ejector apparatus. A conveying pipe typically comprises at least one valve means, by opening and closing which the replacement air coming into the conveying pipe is regulated. Input points at the input end of the material are used in the systems, from which input points the material, such as wastes, is conveyed into the system. The system can also comprise refuse chutes, into which material, such as waste material, is fed and from which the material to be conveyed is conveyed into a conveying pipe by opening a discharge valve means, in which case, by means of the suction effect achieved by the aid of the partial vacuum acting in the conveying pipe and also by means of the surrounding air pressure acting via the refuse chute, material such as e.g. waste material packed into bags, is conveyed from the refuse chute into the conveying pipe. The pneumatic waste conveying systems in question can be utilized particularly well in densely populated urban areas. These types of areas have tall buildings, in which the input of wastes into a pneumatic waste conveying system is performed via a refuse chute or other input point arranged in the building.

Wastes are conveyed pneumatically in a closed system to a reception station, in which the wastes are compressed with a press only after transportation. The pipes of a pneumatic conveying system are in normal cases rather large in diameter, e.g. in the region of 500 mm in their diameter.

Known from publication WO8203200 A1 is a device for fine-grinding, compressing and outputting a high-volume bulk good, more particularly household wastes, by means of which device the waste material conducted through the device can be compacted. In the solution according to the publication large output powers are typically needed, especially in situations in which the device is used to cut or fine-grind a material, in which case the energy consumption of the drive devices and the costs of the drive devices are high. In addition, the passage of stones or other corresponding material between the cutting blades can produce breakage of the blades. Further known from publications WO2011098666, WO2011098667, WO2011098668 and WO2011098669 are solutions in which rotary shapers are applied. Rotary shapers according to prior art comprise a number of rotatable handling means and typically a non-rotating handling means between them. These have proven to be effective for their purpose. A need has arisen, however, to achieve a solution for lighter shaping, in which the dimensions of the waste to be fed in or other reasons do not require powerful shaping according to prior art to be effected. On the other hand, the material packed into waste bags must be made to be conveyed smoothly from a space that is larger in dimension into smaller conveying piping.

The aim of the present invention is to achieve an entirely new type of solution in connection with waste feeder channels and rotary shapers, by means of which solution the drawbacks of prior art solutions are avoided. Another aim of the invention is to achieve a solution for feeding waste bags into conveying piping in such a way that the waste bag is not broken in the handling.

### BRIEF DESCRIPTION OF THE INVENTION

The invention is based on a concept wherein waste to be infed is arranged and handled with one rotatable handling means, through which the material to be fed in is conducted from a first side to a second side, into an output aperture or at least into the proximity of it.

The method according to the invention is mainly characterized by what is stated in the characterization part of claim 1.

The method according to the invention is also characterized by what is stated in claims 2-8.

The apparatus according to the invention is mainly characterized by what is stated in the characterization part of claim 9.

The apparatus according to the invention is also characterized by what is stated in claims 10-15.

The solution according to the invention has a number of important advantages. By means of the invention a particularly efficient solution for the handling of material, more particularly for pneumatic pipe transport, is achieved. With the solution according to the invention, it is possible to organize, convey and, if necessary, shape the material to be fed in to fit into a conveying channel that is smaller in its inner dimensions than the input chute. The power requirement of the rotary shaper according to the invention is smaller than shapers according to prior art. With the solution according to the invention, the material to be fed in from an input chute can be arranged one unit at a time to be conveyed from the chute via the handling means of a shaper into the output aperture and onwards into a conveying channel. With the solution according to the invention, waste material can be efficiently fed and compacted with the rotary shaper, and efficient transportation can be achieved with a significantly smaller pipe size compared to unshaped waste material. By using suction, in addition to gravity, to convey the material to be handled from the rotary shaper into the transport pipe, an advantageous solution for a combination of a rotary shaper and pipe transport is achieved. With the solution according to the invention, waste bags can be made to be fed into piping in such a way that can significantly reduce the susceptibility to breakage of the waste bags.

### BRIEF DESCRIPTION OF THE FIGURES

In the following, the invention will be described in more detail by the aid of an embodiment with reference to the attached drawing, wherein

FIG. 1 presents a simplified diagram of one embodiment of an apparatus according to the invention.

FIG. 2 presents one embodiment of the device according to the invention,

FIG. 3 presents one embodiment of the device according to the invention,

FIG. 4 presents one embodiment of the device according to the invention, sectioned along the line IV-IV of FIG. 5,

FIG. 5 presents one embodiment of the device according to the invention, in a first position of the handling means,

FIG. 6 presents one embodiment of the device according to the invention, sectioned along the line VI-VI of FIG. 7,

FIG. 7 presents one embodiment of the device according to the invention, in a second position of the handling means,

FIG. 8 presents one embodiment of the device according to the invention, sectioned along the line VIII-VIII of FIG. 9,

FIG. 9 presents one embodiment of the device according to the invention, in a third position of the handling means,

FIG. 10 presents one embodiment of the device according to the invention, sectioned along the line X-X of FIG. 11, and

FIG. 11 presents one embodiment of the device according to the invention, in a fourth position of the handling means.

### DETAILED DESCRIPTION OF THE INVENTION

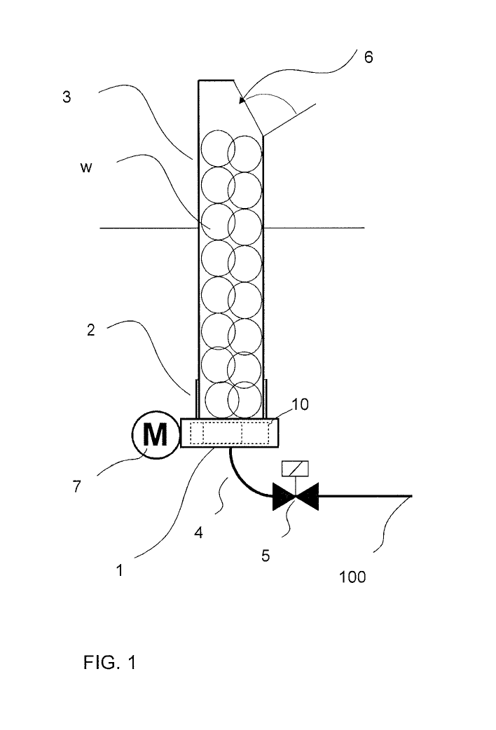

FIG. 1 presents a simplified diagram of one embodiment of the solution according to the invention, in which the rotary shaper device 1 is arranged in connection with a feeder channel 2, into which material is conducted e.g. from an input point 3, such as from an input chute, refuse chute or corresponding. The feeder channel 2 is e.g. a tubular part, inside the wall of which remains space for the material w to be fed in. The material w, such as household waste or other waste packed into bags, is fed, e.g. from an input aperture 6, into the input point 3 and from there onwards, via the feeder channel 2, into the rotary shaper 1. An openable and closable hatch, which is open in the situation of the figure, is in connection with the input aperture 6 in FIG. 1. The input point and feeder channel are in their dimensions, in their cross-sectional area, such that the material w, more particularly waste packed into bags, to be fed in fits into them side by side and one above the other. The material w to be handled is arranged, and if necessary is shaped and compacted, in the rotary shaper, and after handling the material is conducted via an output channel 4 into conveying piping 100 e.g. by means of gravity and/or by means of the suction and/or a pressure difference produced by the drive devices (not presented) of a pneumatic pipe transport system. One advantage of the embodiment of the invention is that the material w can be suitably arranged and be of such a shape that it can be fed in via the output aperture and fits in the transport piping 4, 100 for conveying. In this case conveying piping 100 that is significantly smaller in diameter than usual can be used. According to one embodiment a pipe with a diameter in the region of 150-300 mm, preferably in the region of 200 mm, can be used as a conveying pipe 100. According to one embodiment the material w is packed into bags, the average diameter of which is to some extent larger than the diameter of the conveying pipe. For example the diameter of a bag when filled is in the region of 220-270 mm, when the diameter of the conveying pipe is in the region of 200 mm. In this case with the solution according to the invention a bag and the material in it can be made to be conveyed with the handling means to the point of, or into the proximity of, the output aperture, from where the material is conducted via the output channel 4 into conveying piping 100, e.g. by means of gravity and/or by means of the suction and/or a pressure difference produced by the drive devices of a pneumatic pipe transport system.

In the embodiment of the invention simultaneous suction can be used, in which case the material to be handled can be acted upon with suction or with a pressure difference acting via the conveying pipe 100 and the output coupling 4 when conducting the material through the aperture 20 of the handling means 10 of the rotary shaper 1. The material w is made to be fed in with a rotary shaper typically e.g. one unit, such as a batch of material packed into a bag, at a time. The handling means 10 is ring-like, comprising an aperture 20 from the first side 23 of the handling means, from the inlet side, to the other side 24, to the outlet side. The handling means 10 is rotated in the embodiment of the figure around the vertical axis with the drive device 7. In one embodiment of the invention the aperture 20 of a handling means is arranged eccentrically with respect to the axis of rotation of the handling means 10. Below the rotary shaper 1, in the output channel 4, is a valve means 5. The valve means 5 opens and closes the connection between the rotary shaper 1 and the conveying pipe 100. With the valve means 5 the infeed of material into the conveying pipe 100, and possibly also the suction effect achieved by the partial-vacuum generator of the pneumatic waste-transporting system from the conveying pipe 100 into the rotary shaper 1, is adjusted.

In FIG. 1 material w has been fed into an input point 3, such as into an input chute, from an input aperture 6. The material w is described in the figures with balls, but it can be material of many types and shapes, such as e.g. household waste or other waste packed into bags.

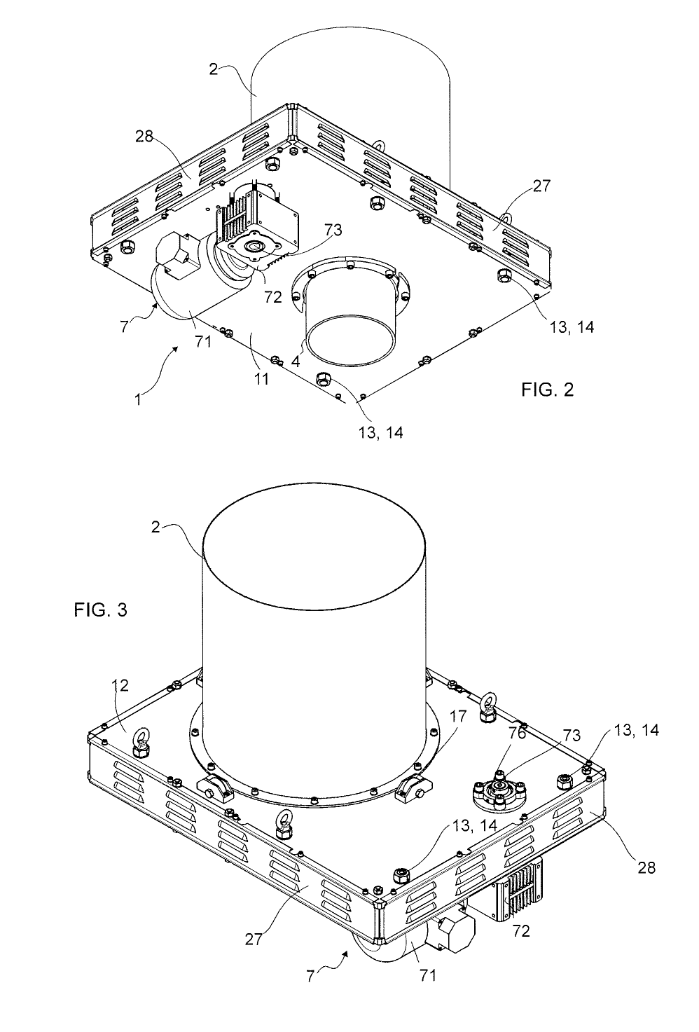

FIGS. 2 and 3 present one rotary shaper 1 according to an embodiment of the invention. In one embodiment the frame of the rotary shaper 1 comprises a lid plate 12 and a base plate 11, which are arranged with support means 13, 14 one above the other at a distance from each other. An input aperture 19 is formed in the lid plate 12, into which a feeder channel 2 is arranged in such a way that the material w is funneled into the input aperture. An aperture 18, which is configured to be face-to-face with the output aperture 40 of the output channel 4, is formed in the base plate 11. The handling means 10 of the rotary shaper is arranged in a manner allowing rotation in the space between the lid plate 12 and the base plate 11. Side walls 27, 28 are arranged between the lid plate 12 and the base plate 11.

A drive device 7 is arranged to rotate the handling means 10. The drive device 7 in the figure comprises a motor 71 arranged on the bottom surface, below it, of the base plate 11 of the rotary shaper 1, a gear transmission 72, which in the figure is an angle transmission, a drive shaft 73, which is arranged rotatably, in the figure with bearing means 76, between the lid plate 12 and the base plate 11. A belt wheel 74 is arranged on the drive shaft 73. In one embodiment a drive belt 75 is arranged to rotate the handling means 10. The outer rim 29 of the handling means 10 is configured to function as a countersurface for the drive belt 75 of the belt transmission. When the drive device rotates the drive shaft 73 the belt wheel 74 moves the drive belt 75, which in turn rotates the handling means 10 around its rotation axis.

The outer rim 29 of the handling means 10 can be shaped suitably. For example, a cambered or barrel-like shape has been observed to be very effective in one embodiment. The rotation trajectory of the handling means 10 is achieved by arranging guide means 15, 16 and/or bearing means 17 on the lid plate and/or on the base plate and countermeans 25, 26, such as a groove, or e.g. a rim-shaped rolling surface or sliding surface, on the ring-shaped handling means 10, on its first surface 23 and/or on its second surface. The guide means and/or bearing means are, according to one embodiment, arranged in a distributed manner on the rotation rim of the handling means, in the area between the outer rim 29 of the handling device and the most extensive rotation rim of the edge 21 of the aperture 20.

Typically the guide means 15, 16 and/or the bearing means 17 are arranged between the ring-shaped handling means 10 and the lid plate 12 and/or base plate 11 of the frame part. It can also be conceived that separate rolling means 17 are not used, but instead the handling means is arranged to rest on the base plate 11 and/or on the lid plate 12 of the frame part.

The rotary shaper 1 thus comprises a frame, onto which a ring-like handling means is arranged. In the vertical direction the ring-like handling means 10, which comprises an aperture 20 leading from the first side 23 to the second side 24 of the handling means, is arranged below the input aperture 19 of the material to be handled. The ring-like handling means 10 is configured around a geometric axis in connection with a relative rotational movement, which axis is mainly identical with the geometric axis of the input chute 2, to convey material w through the ring-like handling means 10 by gravity and/or by means of the suction/pressure-difference produced by the partial-vacuum generators of a pneumatic materials handling system, such as of a pipe transport system. The material fed in with the handling means is fetched from the rim and arranged in the center of the handling means at least by shaping the bulk good with the combined action of the aperture 20 of the rotating handling means, the edge and at least one rigid (non-rotating) aperture, the input aperture 19 and/or the output aperture 18, 40. The speed of rotation and the direction of rotation of the rotatable handling means 10 can be changed.

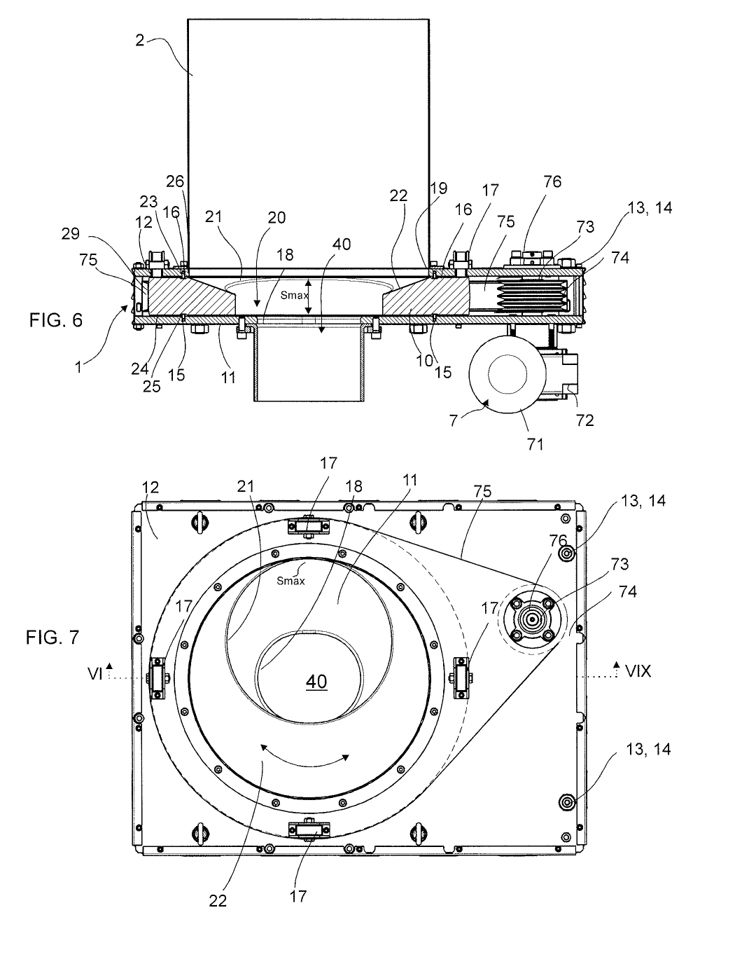

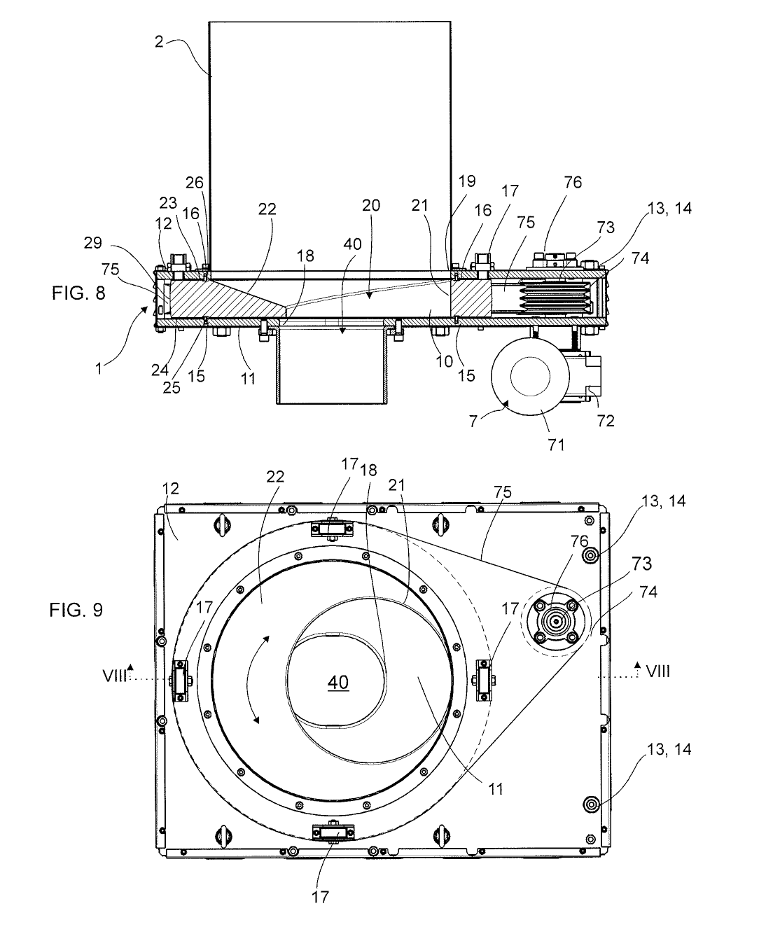

The handling means in the embodiment according to FIGS. 6, 7,8, 9, 10 and 11 has an aperture 20 of round shape. The output aperture 18 of the base plate 11 is oval shaped in the figures. The output aperture 18 of the base plate then has curved sections and short, straight sections between them. The aperture 20 of the handling means is arranged asymmetrically with respect to the axis of rotation of the handling means. The aperture 20 of the handling means has an inner surface 21. The inner surface 21 of the aperture of the handling means shapes the material to be handled. The figures illustrate different situations when the shaping means 10 are moved during the handling of the material.

The rotary shaper thus functions in a way as a re-arranger and compactor (i.e. as a formatter) of the material w to be handled. The handling means 10 of the rotary shaper arranges and shapes the material to be handled so that it fits into the output aperture 18 of the base plate 11 and onwards into the aperture 40 of the output channel.

In the case of the figures, the shape of the aperture 20 of the handling means 10 is a symmetrical hole (shape), e.g. round. It can be conceived that it is also some other shape, such as oval. A material unit to be handled, such as waste material packed into a bag, remains in the aperture 20 when the handling means is rotating, and is displaced from the aperture 20 onwards into the output aperture.

The direction of rotation of the handling means can be changed. Should too large a load arise, the wheel stops and the direction of rotation is changed.

It has been shown that the power required of the drive device is extremely small, e.g. in one embodiment in the region of only 0.5-1.5 kW. The power requirement depends on the operating site.

When the handling means 10 is rotating, the inner surface 21 of the aperture 20 determines the through-passage aperture 20 through the handling means, and onwards into the output aperture 18, 40, that is free of obstacles. Means, such as a threaded groove or a ridge, which when the handling means rotates in the input direction at the same time feeds the material to be handled from the aperture 20 onwards in the handling direction, can thus be formed on the inner surface 21 of a handling means.

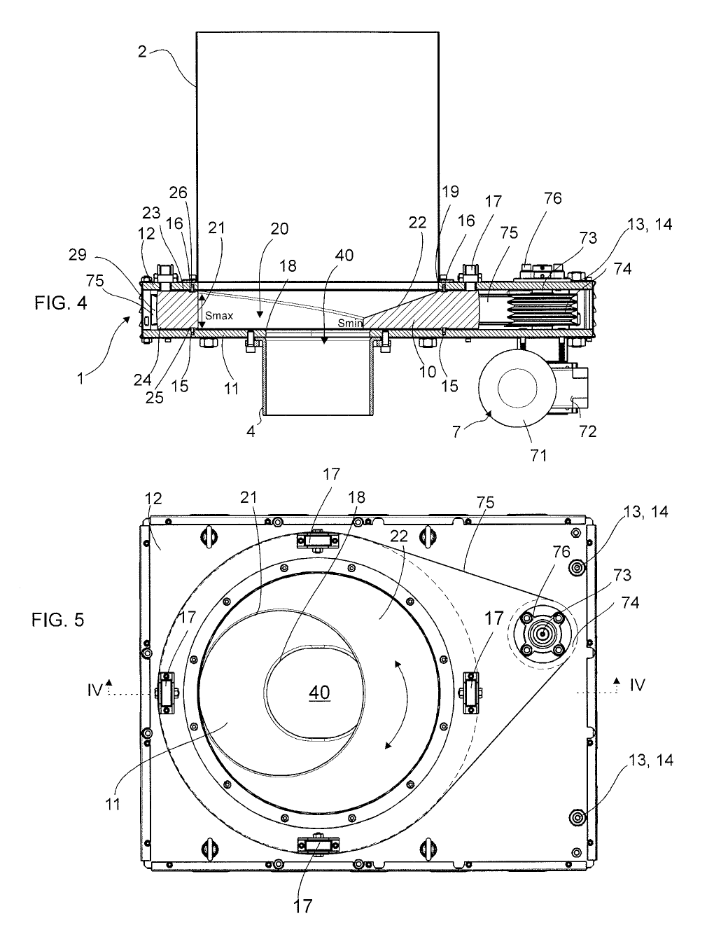

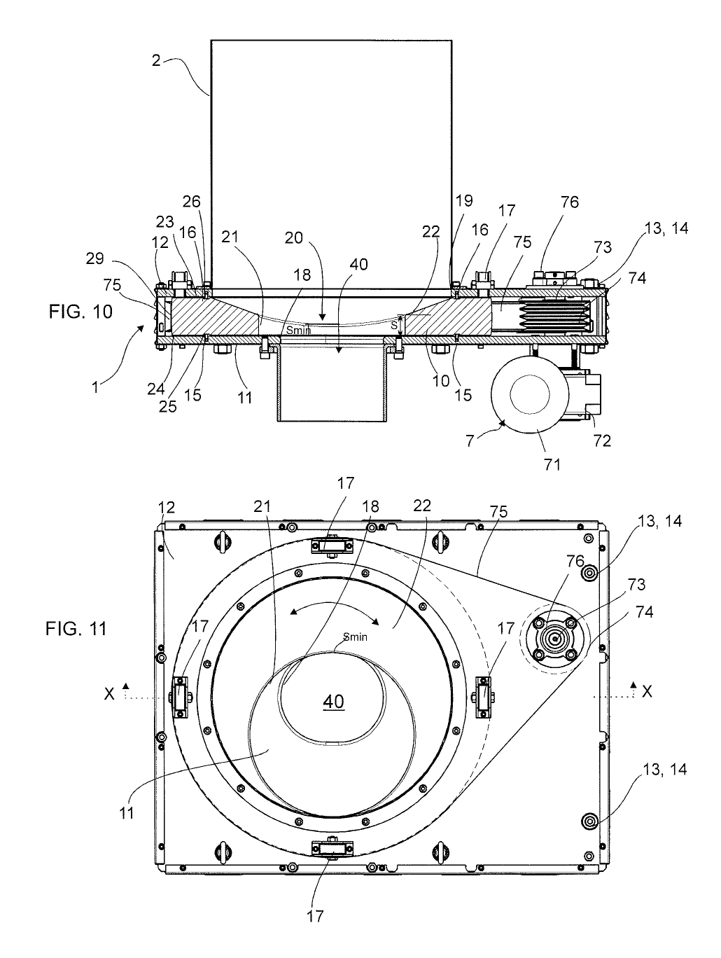

In the embodiment according to the figures the surface 22 of the handling means 10 is at least partly sloping from the side of the input aperture 19 towards the edge of the wall 21 of the aperture 20 of the handling means, at least towards that edge section of the wall that is close to the output aperture 18, 40. With the sloping any liquids caused by the input chute and/or the material can be conducted onwards into the piping. The top surface of the handling means can, according to one embodiment, be straight. In the figure, the thickness of the handling means changes in the area that is at the point of the input aperture 19. According to one embodiment the thickness S of the handling means 10, i.e. the distance from the bottom surface 24 of the handling means, at the point of the edge 21 of the aperture 20, decreases towards the output aperture 18, 40. This can be seen e.g. from FIGS. 4, 6, 7, 10 and 11, in which is marked in FIG. 6 the thickness S at its maximum (Smax) of the wall of the edge of the aperture, when the distance from the output aperture 40 is greatest, and in FIG. 10 the thickness of the wall of the edge 21 of the aperture 20 is at its minimum (Smin), when the distance from the output aperture 40 is at its smallest (in FIGS. 10 and 11). The part of the section of the edge 21 of the aperture 20 of the handling means is, in actual fact, on the inside of the rim of the edge 18 of the output aperture 40.

The ring-like handling means 10, or at least a part of it, and the inner surface 21 of its aperture 20 can be patterned and/or arranged to be such in their shape that its rotational movement simultaneously feeds material onwards from the aperture 20 towards the output end and the output aperture 40.

In the embodiment of the figures, the surface 22 on the side of the input aperture 19 of the handling means is formed to slope towards the edge 21 of the aperture 20. The sloping shape conducts liquids towards the output aperture.

The material conducted through the aperture 20 of the handling means 10 in the rotary shaper is compressed and compacted. The smallest rotation rim of the edge of the aperture 20 of the rotary shaper is, according to one embodiment, arranged to be to some extent smaller than the outer edge 18 of the output aperture following it.

When the handling means 10 is rotating, the surface 21 of the edge of the aperture determines the through-passage aperture through the handling means that is free of obstacles. Means, such as a threaded groove or a ridge, which when the handling means rotates in the input direction at the same time feeds the material to be handled from the aperture onwards in the handling direction, can thus be formed on the inner surface 21 of the handling means.

The general operation of a prior-art rotary press is presented e.g. in publication WO8203200 A1, and it is not described in more detail in this publication.

The degree of shaping can be influenced with the size and shape of the aperture of the shaping means, and also with the patterning on the inner edge of the aperture. Household waste fed as a shaped stream into the conveying pipe is conveyed in the pipe onwards by means of suction and/or a pressure difference to the reception location, such as to a waste station or corresponding.

The rotary shaper 1 is, according to one embodiment, preferably driven in a sequence, which has a certain set duration t₁, for the extent of which the handling means 10 is rotated with the drive device 7 in a first direction, after which the direction of rotation is changed. After this the handling means 10 is rotated in the opposite direction for the extent of a second period of time t₂. The first direction is the actual handling direction of the shaper. The second direction is that in which the possible blade part of the handling means is configured to cut the material. The rotation duration t₂ of the second direction of rotation is typically shorter than the duration t₁ of the first direction of rotation. According to one embodiment preferably an equation is followed, according to which t₂=0.5*t₁.

Typically the rotation duration t₁ of the first handling direction is in the order of 10 seconds and the duration t₂ of the opposite direction of rotation is 5 seconds.

The rotary shaper thus functions in a way as a re-arranger and compactor (i.e. as a formatter). Under the effect of suction the handling means 10 of the rotary shaper shape the material to be handled so that it fits into the output aperture and onwards into the conveying pipe 100.

The general operation of a prior-art rotary shaper is presented e.g. in publications WO8203200, WO2011098666, WO2011098667, WO2011098668 and WO2011098669, and it is not described in more detail in this publication.

The invention thus relates to a method for handling material in a pneumatic pipe transfer system, in which material, such as waste material, is input from an input aperture of an input point 3, such as from the input aperture of a refuse chute or of some other input point, and is conducted along a feeder channel 2 with a shaper device 1 arranged in connection with the input point or in the proximity of it, in which case the material to be handled is conducted into the shaper device and/or through it by the aid of at least partly gravity and/or the suction and/or a pressure difference of the pneumatic pipe transport system. In the method the material is handled with one handling means 10 in a shaper device 1, which handling means is rotated around an axis of rotation when handling material and which handling means comprises an aperture 20, which is arranged eccentrically with respect to the axis of rotation of the handling means, that the rotatable handling means 10 arranges the material to be infed into the proximity of the output aperture and, if necessary, shapes the material, together with at least an edge 18 of the output aperture of the rotary shaper and/or the wall of the output channel 4, when the handling means 10 is rotated with the drive device 7.

According to one embodiment the thickness S of the handling means 10, i.e. the distance of its top surface from the bottom surface 24 of the handling means, at the point of the edge 21 of the aperture 20, decreases towards the output aperture 18, 40 of the shaper device.

According to one embodiment the handling means 10 of the rotary shaper feeds the material to be handled through the aperture 20 of the handling means and/or through the output aperture 18, 40 of the shaper device, when rotating the handling means in the first direction.

According to one embodiment the material is shaped with the wall 21 of the aperture of the handling means and the edge 18 of the output aperture and/or the wall of the output channel 40.

According to one embodiment the direction of rotation of the handling means 10 can be changed.

According to one embodiment a section 22 of the surface inclined to slope towards the aperture 20 is formed in the top surface 24 of the handling means.

According to one embodiment the pneumatic materials handling system is a pipe transport system of material, more particularly waste material, wherein waste, most preferably packed into bags, is conveyed from an input point into a separating device, where the waste being transported is separated from the transporting air.

According to one embodiment the rotatable handling means 10 is driven in sequences, in which case the handling means 10 is rotated in a first direction for the extent of a first period of time t₁ and after that in the opposite direction for a second period of time t₂.

The invention also relates to an apparatus for handling material in a pneumatic pipe transport system, in which material, such as waste material, is input from an input aperture of an input point 3, such as from the input aperture of a refuse chute or of some other input point, and is conducted along a feeder channel 2 with a shaper device 1 arranged in connection with the input point or in the proximity of it, in which case the material to be handled is conducted into the shaper device and/or through it by the aid of at least partly gravity and/or the suction and/or a pressure difference of the pneumatic pipe transport system. The apparatus comprises a handling means 10 in a shaper device 1, which handling means is configured to be rotated around an axis of rotation when handling material and which comprises an aperture 20, which is arranged eccentrically with respect to the axis of rotation of the handling means, that the rotatable handling means 10 is configured to arrange the material to be infed into the proximity of the output aperture and, if necessary, to shape the material, together with at least an edge 18 of the output aperture of the rotary shaper and/or the wall of the output channel 4, when the handling means 10 is rotated with the drive device 7.

According to one embodiment the thickness S of the handling means 10, i.e. the distance of its top surface from the bottom surface 24 of the handling means, at the point of the edge 21 of the aperture 20, decreases towards the output aperture 18, 40 of the shaper device.

According to one embodiment the handling means 10 of the rotary shaper feeds the material to be handled through the aperture 20 of the handling means and/or through the output aperture 18, 40 of the shaper device, when rotating the handling means in the first direction.

According to one embodiment the direction of rotation of the handling means 10 can be changed.

According to one embodiment a section 22 of the surface inclined to slope towards the aperture 20 is formed in the top surface 24 of the handling means.

According to one embodiment the pneumatic materials handling system is a pipe transport system of material, more particularly waste material, wherein waste, most preferably packed into bags, is conveyed from an input point into a separating device, where the waste being transported is separated from the transporting air.

According to one embodiment the direction of rotation of the rotatable handling means 10 is configured to be changeable, e.g. in sequences.

Typically the material is waste material, such as waste material arranged in bags. A refuse chute can be configured to be a part of a pneumatic waste conveying system or it can be a separate part, in which waste material is conducted into a waste room, waste tank or corresponding.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1. Method for handling material in a pneumatic pipe transfer system, in which material, such as waste material, is input from an input aperture of an input point, such as from the input aperture of a refuse chute or of some other input point, and is conducted along a feeder channel with a shaper device arranged in connection with the input point or in the proximity of it, in which case the material to be handled is conducted into the shaper device and/or through it by the aid of at least partly gravity and/or the suction and/or a pressure difference of the pneumatic pipe transport system, characterized in that in the method the material is handled with one handling means in a shaper device, which handling means is rotated around an axis of rotation when handling material and which handling means comprises an aperture, which is arranged eccentrically with respect to the axis of rotation of the handling means, in that the rotatable handling means arranges the material to be infed into the proximity of the output aperture and, if necessary, shapes the material, together with at least an edge of the output aperture of the rotary shaper and/or the wall of the output channel, when the handling means is rotated with the drive device.

2. Method according to claim 1, characterized in that the handling means of the rotary shaper feeds the material to be handled through the aperture of the handling means and/or through the output aperture of the shaper device, when rotating the handling means in the first direction.

3. Method according to claim 1, characterized in that the material is shaped with the wall of the aperture of the handling means and the edge of the output aperture of the rotary shaper and/or the wall of the output channel.

4. Method according to claim 1, characterized in that the thickness of the handling means, i.e. the distance of its top surface from the bottom surface of the handling means, at the point of the edge of the aperture, decreases towards the output aperture of the shaper device.

5. Method according to claim 1, characterized in that the direction of rotation of the handling means can be changed.

6. Method according to claim 1, characterized in that a section of the surface inclined to slope towards the aperture is formed in the top surface of the handling means.

7. Method according to claim 1, characterized in that the pneumatic materials handling system i.e. a pipe transport system of material, more particularly waste material, wherein waste, most preferably packed into bags, is conveyed from an input point into a separating device, where the waste being transported is separated from the transporting air.

8. Method according to claim 1, characterized in that the rotatable handling means is driven in sequences, in which case the handling means is rotated in a first direction for the extent of a first period of time and after that in the opposite direction for a second period of time.

9. Apparatus for handling material in a pneumatic pipe transfer system, in which material, such as waste material, is input from an input aperture of an input point, such as from the input aperture of a refuse chute or of some other input point, and is conducted along a feeder channel with a shaper device arranged in connection with the input point or in the proximity of it, in which case the material to be handled is conducted into the shaper device and/or through it by the aid of at least partly gravity and/or the suction and/or a pressure difference of the pneumatic pipe transport system, characterized in that the apparatus comprises one handling means in a shaper device, which handling means is configured to be rotated around an axis of rotation when handling material and which handling means comprises an aperture, which is arranged eccentrically with respect to the axis of rotation of the handling means, in that the rotatable handling means is configured to arrange the material to be infed into the proximity of the output aperture and, if necessary, to shape the material, together with at least an edge of the output aperture of the rotary shaper and/or the wall of the output channel, when the handling means is rotated with the drive device.

10. Apparatus according to claim 9, characterized in that the handling means of the rotary shaper feeds the material to be handled through the aperture of the handling means and/or through the output aperture of the shaper device, when rotating the handling means in the first direction.

11. Apparatus according to claim 9, characterized in that the direction of rotation of the handling means is configured to be changeable.

12. Apparatus according to claim 9, characterized in that the thickness of the handling means, i.e. the distance of its top surface from the bottom surface of the handling means, at the point of the edge of the aperture, decreases towards the output aperture of the shaper device.

13. Apparatus according to claim 9, characterized in that a section of the surface inclined to slope towards the aperture is formed in the top surface of the handling means.

14. Apparatus according to claim 9, characterized in that the pneumatic materials handling system is a pipe transport system of material, more particularly waste material, wherein waste, most preferably packed into bags, is conveyed from an input point into a separating device, where the waste being transported is separated from the transporting air.

15. Apparatus according to claim 9, characterized in that the direction of rotation of the rotatable handling means is configured to be changeable in sequences.

16. Method according to claim 2, characterized in that the material is shaped with the wall of the aperture of the handling means and the edge of the output aperture of the rotary shaper and/or the wall of the output channel.

17. Method according to claim 2, characterized in that the thickness of the handling means, i.e. the distance of its top surface from the bottom surface of the handling means, at the point of the edge of the aperture, decreases towards the output aperture of the shaper device.

18. Method according to claim 3, characterized in that the thickness of the handling means, i.e. the distance of its top surface from the bottom surface of the handling means, at the point of the edge of the aperture, decreases towards the output aperture of the shaper device.

19. Method according to claim 2, characterized in that the direction of rotation of the handling means can be changed.

20. Method according to claim 3, characterized in that the direction of rotation of the handling means can be changed.
